(19) United States
(12) Patent Application Publication
(10) Pub. No.: US 2003/0074390 A1
(43) Pub. Date: Apr. 17, 2003

(54) Hardware to support non-blocking synchronization

(76) Inventor: Richard L. Hudson, Florence, MA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/977,509

(22) Filed: Oct. 12, 2001

(51) Int. Cl. G06F 9/00; G06F 1/12

(52) U.S. Cl. 709/108; 709/400

(57) ABSTRACT

A method to support the non-blocking synchronization between threads of a multi-thread application. In one embodiment a thread switch flag (H-flag) is added to the system flags register. An instruction set allows the H-flag to be used to facilitate synchronization between application threads using resources local to the CPU. In one embodiment the instruction set may be used to generate a non-blocking object allocation algorithm. The algorithm allows the thread to complete an instruction sequence and subsequently validate the result. The present invention allows the sequence to execute and if an interruption occurs during execution, the sequence is abandoned midway and repeated. During the instruction sequence, the H-flag indicates an interruption. If the thread is interrupted, the instruction sequence is repeated. The sequence is designed to be idempotent, i.e., it can be abandoned mid-sequence and repeated without consequence.

### FIELD OF THE INVENTION

This invention relates generally to synchronization of threads in a multi-thread application, and more specifically to hardware instructions that support non-blocking synchronization of competing application threads.

### BACKGROUND OF THE INVENTION

Today advanced, object oriented, computer programming languages such as JAVA and C# support multi-threaded applications. When two or more threads of a program are running concurrently, a mechanism is required to ensure that access to stored information is properly shared by competing threads. For example, consider a large commercial database accessible by hundreds of simultaneous users. Each thread of the database program may be connected to a single end-user. Each of these threads may be competing to access the stored information of the database such as inventory. Each of the threads may access stored data and then write back modified data to memory. Because multiple threads are competing for access to a shared memory resource, the operating system (OS) may interrupt one thread and start running a different thread. This may cause the intervening thread to store erroneous data (i.e., a subsequent intervening thread is not aware of a modification of the shared memory resource by the previous thread). Such storage of erroneous data can be avoided by implementing a resource locking algorithm. In general, such algorithms work as follows. A thread will access a shared memory resource and obtain a lock on that resource. While the lock is in place, no other threads can gain access to the resource and therefore no intervening modification of the data can occur. By obtaining a lock, the thread becomes the single owner of the resource and may modify the resource as necessary. Subsequently, the lock is released and the resource becomes available to other threads. This technique is known as blocking synchronization because it blocks the modification of in-use shared resources. Although erroneous data is prevented, the number of CPU cycles required to obtain a lock on the shared resource may be from ten to one hundred times greater than simply modifying the stored data. A thread may only require 5-10 CPU cycles to accomplish a task, but may require 200 or more CPU cycles to obtain the lock, complete the task, and release the resource. This taxes the CPU causing bottlenecks that may adversely affect system performance.

The prior art method for doing allocation splits the contiguous allocation area into two parts separated by a “frontier pointer”. Memory before the frontier pointer holds allocated objects and memory past the frontier pointer hold unallocated zeroed memory. Bumping the frontier pointer by the size of the object does allocation. If each thread has its own allocation area this is a simple unsynchronized sequence. If not then the allocation is typically synchronized using atomic hardware such as compare/exchange (CMPXCHG) also known as compare and swap.

Such a sequence is included in Appendix A. The CMPXCHG sequence of Appendix A begins after A with moving the frontier pointer located in memory at [fp] into the register reg. After B this value is moved into the result register res. This register will eventually hold a pointer to the new object. After C the new frontier pointer is calculated by adding the size of the object to the old frontier pointer held in reg. The old frontier pointer in res is moved to the AL register where it is used by the CMPXCHG instruction. After E the CMPXCHG instruction compares the value in the AL register with the [fp] value in memory. If these values are the same the value in reg is stored at [fp]. If so a pointer to the virtual method table for this object is stored at the location specified by [res] and we are done. If [fp] and reg do not match this indicates that the allocation sequence was interrupted at some point by a competing thread. The CMPXCHG instruction is a global operation that has to be synchronized with every CPU in the system. Other CPUs are informed not to access the memory bus. Therefore, if there is a value for [fp] in one of the CPU caches that cache line is invalidated. This CMPXCHG process can take up a couple of orders of magnitude more time as the other instructions in the sequence.

### BRIEF DESCRIPTION OF THE DRAWINGS

The present invention is illustrated by way of example, and not limitation, by the figures of the accompanying drawings in which like references indicate similar elements and in which:

FIG. 1 is a process flow diagram in accordance with one embodiment of the present invention; and

FIG. 2 is an illustration of an exemplary computing system for implementing the present invention.

### DETAILED DESCRIPTION

An augmented computer system hardware instruction set that includes a thread switch indicator is described. In one embodiment a thread switch flag (H-flag) is added to the system flags register. The accompanying instruction set allows the H-flag to be used to facilitate synchronization between application threads. In one embodiment the thread switch indicator and accompanying instruction set may be used to generate a non-blocking object allocation algorithm. The algorithm allows the thread to complete an instruction sequence and subsequently validate the result. During the instruction sequence, the H-flag indicates an interruption. If the thread is interrupted, the instruction sequence is repeated. Rather than lock the resource on the off chance that the sequence will be interrupted, the present invention allows the sequence to execute and if an interruption occurs during execution, the sequence is abandoned midway and repeated. Each CPU needs its own resource that can only be accessed by the threads running on that CPU. If the shared resource is not local to the CPU then this technique will not work.

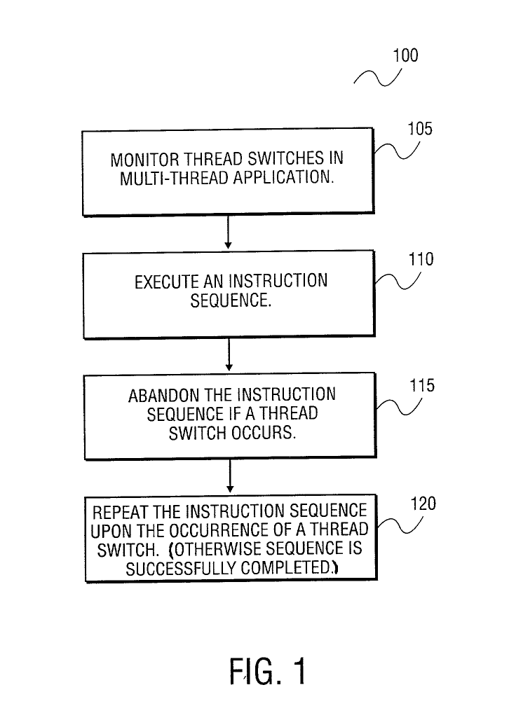

FIG. 1 is a process flow diagram in accordance with one embodiment of the present invention. The process 100, shown in FIG. 1 begins with operation 105 in which the thread switching of a multi-thread application is monitored. At operation 110, while the thread switching monitoring continues, an instruction sequence is executed. The instruction sequence contains instructions to determine if a thread switch has occurred. For example, in one embodiment, upon resumption of an application thread a thread switch indicator (e.g., an H-flag) will be set. One or more of the instructions within the sequence may monitor the thread switch indicator to determine if a thread switch has occurred. If a thread switch has occurred during the sequence, the instructions following the thread switch will not become apparent to other threads since these instructions only have visible side effects if the thread switch flag has not been set. At operation 120 the sequence is repeated if the sequence was interrupted. The sequence is designed to be idempotent so that it can be abandoned in mid-sequence and repeated without any consequences.

The present invention, in one embodiment, implements the H-flag to determine if there has been any conflict between threads during an instruction sequence. If conflict has occurred, the sequence is repeated. This allows partially completed sequences to be safely abandoned without the need for locking resources or for computationally intensive instructions such as CMPXCHG. For example, during an allocation sequence, if thread conflict occurs, the sequence is abandoned and repeated.

The H-flag may be stored in one of the system registers, for example the H-flag may be stored in the eflags register of the Intel Architecture 32 (IA32) available from Intel Corporation, Santa Clara, Calif. The H-flag is accompanied by a hardware instruction set that may include:

cmovh, (conditional move if thread switched flag is set),

cmovnh, (conditional move if thread switched flag is clear),

jh (jump if thread switched flag is set),

jnh (jump if thread switched flag is not set),

clh (clear thread switch flag)

sth (set thread switch flag).

In one embodiment the H-flag and its accompanying instruction set are used to implement the non-blocking frontier pointer based allocation instruction sequence described below in reference to Appendix B.

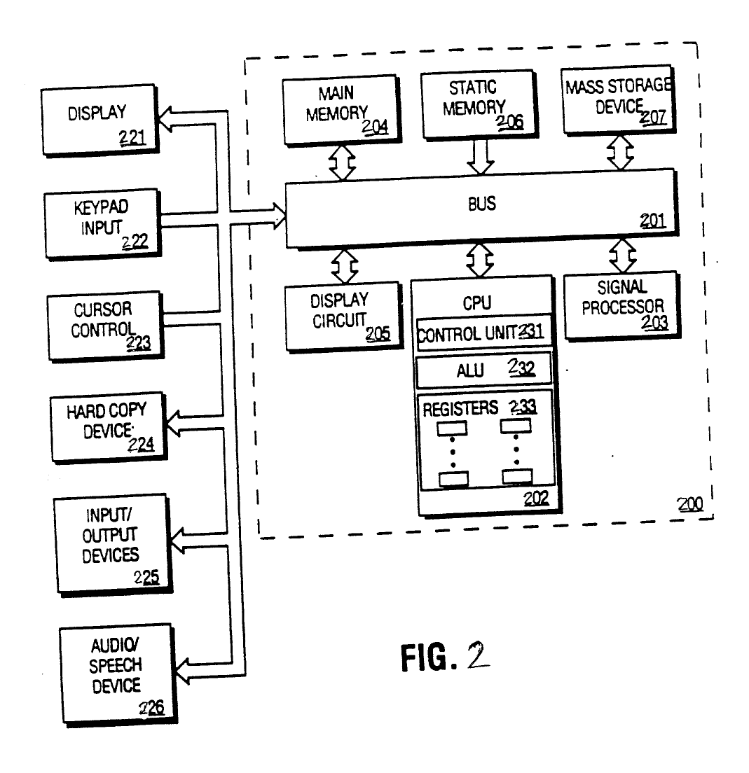

FIG. 2 is a diagram illustrating an exemplary computing system 200 for implementing the present invention. The thread switch flag, accompanying hardware instructions, and non-blocking object allocation algorithm described herein can be implemented and utilized within computing system 200, which can represent a general-purpose computer, portable computer, or other like device. The components of computing system 200 are exemplary in which one or more components can be omitted or added. For example, one or more memory devices can be utilized for computing system 200.

Referring to FIG. 2, computing system 200 includes a central processing unit 202 and a signal processor 203 coupled to a display circuit 205, main memory 204, static memory 206, and mass storage device 207 via bus 201. Computing system 200 can also be coupled to a display 221, keypad input 222, cursor control 223, hard copy device 224, input/output (I/O) devices 225, and audio/speech device 226 via bus 201.

Bus 201 is a standard system bus for communicating information and signals. CPU 202 and signal processor 203 are processing units for computing system 200. CPU 202 or signal processor 203 or both can be used to process information and/or signals for computing system 200. CPU 202 includes a control unit 231, an arithmetic logic unit (ALU) 232, and several registers 233, which are used to process information and signals. Signal processor 203 can also include similar components as CPU 202.

Main memory 204 can be, e.g., a random access memory (RAM) or some other dynamic storage device, for storing information or instructions (program code), which are used by CPU 202 or signal processor 203. Main memory 204 may store temporary variables or other intermediate information during execution of instructions by CPU 202 or signal processor 203. Static memory 206, can be, e.g., a read only memory (ROM) and/or other static storage devices, for storing information or instructions, which can also be used by CPU 202 or signal processor 203. Mass storage device 207 can be, e.g., a hard or floppy disk drive or optical disk drive, for storing information or instructions for computing system 200.

Display 221 can be, e.g., a cathode ray tube (CRT) or liquid crystal display (LCD). Display device 221 displays information or graphics to a user. Computing system 200 can interface with display 221 via display circuit 205. Keypad input 222 is a alphanumeric input device with an analog to digital converter. Cursor control 223 can be, e.g., a mouse, a trackball, or cursor direction keys, for controlling movement of an object on display 221. Hard copy device 224 can be, e.g., a laser printer, for printing information on paper, film, or some other like medium. A number of input/output devices 225 can be coupled to computing system 200. A non-blocking allocation algorithm in accordance with the present invention can be implemented by hardware and/or software contained within computing system 200. For example, CPU 202 or signal processor 203 can execute code or instructions stored in a machine-readable medium, e.g., main memory 204.

The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, flash memory devices. The code or instructions may be represented by carrier-wave signals, infrared signals, digital signals, and by other like signals.

In one embodiment a thread switch flag (H-flag) is added to the system flags register. The accompanying instruction set allows the H-flag to be used to facilitate synchronization between application threads. The software protocol that accompanies this flag sets the thread switch flag in the eflags register using a “sth” instruction whenever an application thread is resumed, either by virtual machine thread scheduler or the operating system's thread scheduler.

An exemplary non-blocking frontier pointer based allocation instruction sequence is included as Appendix B. Referring to the sequence in Appendix B, the sequence demonstrates a simple non-blocking frontier pointer based allocation. The instruction following label A loads the frontier pointer into a register. The instruction after B moves that instruction to the result register. The instruction after C calculates a new frontier pointer. The instruction after D installs the vtable into the new object. The instruction after E commits the sequence by updating the frontier pointer. The new instructions can be used as follows. A thread switch can happen at one of the 7 locations (labeled A-G) relevant to the sequence. We will consider what happens if a thread switch happens at each of these locations. If a thread switch happens before A or at A, B, C or D then the first three instructions are executed and the first cmovh instructions does not store the virtual method table into the heap. Likewise the second cmovh does not update the frontier pointer. These instructions result in no visible changes to the frontier pointer or the heap and it can be repeated without consequence. If the thread switch happens at location E then there has been a vtable value stored into a location past the frontier pointer. This is not harmful since other threads will simple rewrite the virtual method table pointer when it does an allocation and this thread will repeat the sequence. If a switch happens at F then we already committed the allocation. This is actually the most interesting case. The newly allocated object is valid since it holds a virtual method table pointer. The sequence will be repeated and the newly allocated object will be abandoned. This isn't a problem since the unused object will be reclaimed by the next garbage collection. If a switch happens at G or after then the sequence has been committed and the new object is available. The redo logic simple clears the H-flag and repeats the sequence.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

[image]

[image]

What is claimed is:

1. A method comprising:
monitoring thread switches in a multiple-threaded application;
executing a non-blocking thread synchronization sequence; and
interrupting the non-blocking thread synchronization sequence upon the occurrence of a thread switch.

2. The method of claim 1 further comprising:
repeating the non-blocking thread synchronization sequence.

3. The method of claim 2 wherein the multiple-threaded applications are supported by a computer programming language selected from the group consisting of JAVA, C#, CLI, LISP, and Pascal.

4. The method of claim 2 wherein the thread switches are monitored through use of a thread switch flag.

5. The method of claim 2 wherein the non-blocking thread synchronization sequence is a frontier pointer-based allocation sequence.

6. The method of claim 5 wherein executing the frontier pointer-based allocation sequence comprises:
loading a frontier pointer into a first register;
moving a current value of the frontier pointer to a second register;
adding the size of an object to be allocated to the first register such that a new frontier pointer is determined;
storing a virtual method table to the second register if a thread switch has not occurred; and
updating the frontier pointer with the new frontier pointer if a thread switch has not occurred.

7. A machine-readable medium that provides executable instructions, which when executed by a processor, cause the processor to perform a method, the method comprising:
monitoring thread switches in a multiple-threaded application;
executing a non-blocking thread synchronization sequence; and interrupting the non-blocking thread synchronization sequence upon the occurrence of a thread switch.

8. The machine-readable medium of claim 7 further comprising:
repeating the non-blocking thread synchronization sequence.

9. The machine-readable medium of claim 8 wherein the multiple-threaded applications are supported by a computer programming language selected from the group consisting of JAVA, C#, CLI, LISP, and Pascal.

10. The machine-readable medium of claim 8 wherein the thread switches are monitored through use of a thread switch flag.

11. The machine-readable medium of claim 8 wherein the non-blocking thread synchronization sequence is a frontier pointer-based allocation sequence.

12. The machine-readable medium of claim 11 wherein executing the frontier pointer-based allocation sequence comprises:
loading a frontier pointer into a first register;
moving a current value of the frontier pointer to a second register;
adding the size of an object to be allocated to the first register such that a new frontier pointer is determined;
storing a virtual method table to the second register if a thread switch has not occurred; and
updating the frontier pointer with the new frontier pointer if a thread switch has not occurred.

13. A computing system comprising:
at least one central processing unit, the central processing unit executing multi-threaded applications;
a thread switch indicator to indicate the occurrence of a thread switch; and
an instruction set to implement non-blocking thread synchronization sequences such that partially completed non-blocking thread synchronization sequences used to share resources local to the at least one central processing unit can be abandoned and repeated upon the occurrence of a thread switch.

14. The computing system of claim 13 wherein the instruction set includes:
a set instruction to set the thread switch indicator upon the occurrence of a thread switch;
a first conditional move instruction to move data if the thread switch indicator is set;
a second conditional move instruction to move data if the thread switch indicator is not set;
a first jump instruction to bypass instructions if the thread switch indicator is set;
a second jump instruction to bypass instructions if the thread switch indicator is not set; and
a clear instruction to clear the thread switch indicator.

15. The computing system of claim 14 wherein the thread switch indicator is a thread switch flag.

16. The computing system of claim 13 wherein each of the at least one central processing units has a single allocation area and the non-blocking thread synchronization sequence is a frontier pointer-based allocation sequence.

17. The computing system of claim 13, wherein the computing system uses a computer programming language selected from the group consisting of JAVA, C#, CLI, LISP, and Pascal.

18. A computer system instruction set comprising:
a thread switch indicator to indicate the occurrence of a thread switch;
a set instruction to set the thread switch indicator upon the occurrence of a thread switch;
a first conditional move instruction to move data if the thread switch indicator is set;
a second conditional move instruction to move data if the thread switch indicator is not set;
a first jump instruction to bypass instructions if the thread switch indicator is set;
a second jump instruction to bypass instructions if the thread switch indicator is not set; and
a clear instruction to clear the thread switch indicator.

19. The computer system instruction set of claim 18 implemented as hardware.

20. The computer system instruction set of claim 18 wherein the thread switch indicator is a thread switch flag.

21. The computer system instruction set of claim 18 used to implement a non-blocking thread synchronization sequence for the execution of multi-threaded applications.

22. The computer system instruction set of claim 21 wherein the non-blocking thread synchronization sequence is a frontier pointer-based allocation sequence.
